(19) United States
(12) Patent Application Publication
(10) Pub. No.: US 2008/0008205 A1
(43) Pub. Date: Jan. 10, 2008

(54) DATA ACCELERATION APPARATUS FOR iSCSI AND iSCSI STORAGE SYSTEM USING THE SAME

(76) Inventors: Byung Kwon JUNG, Daejeon (KR); Song Woo SOK, Daejeon (KR); June KIM, Daejeon (KR); Myung Joon KIM, Daejeon (KR)

Correspondence Address: LADAS & PARRY LLP, 224 SOUTH MICHIGAN AVENUE, SUITE 1600, CHICAGO, IL, 60604, US

(21) Appl. No.: 11/769,813

(22) Filed: Jun. 28, 2007

(30) Foreign Application Priority Data
Jul. 7, 2006 (KR) 10-2006-0064072

(51) Int. Cl. H04L 12/28

(52) U.S. Cl. 370/419

(57) ABSTRACT

A data acceleration apparatus for Internet small computer system interface (iSCSI) and an iSCSI storage system using the same are provided. A data acceleration apparatus comprises an I/O processor, a memory, a TOE controller, and an IPsec controller. The I/O processor is connected to an iSCSI storage system through a PCI bus and controls a PCI bridge and the memory. The memory stores data according to the control by the I/O processor, serves as a buffer for processing a TCP/IP and an IPsec protocol, and provides a data storage space. The TOE controller receives data to be read or written through the I/O processor, offloads a stack of the TCP/IP, and processes the TCP/IP. The IPsec controller processes the IPsec protocol for the inputted and outputted data.

### RELATED APPLICATION

The present application is based on, and claims priority from, Korean Application Number 10-2006-64072, filed Jul. 7, 2006, the disclosure of which is hereby incorporated by reference herein in its entirety.

### BACKGROUND OF THE INVENTION

1. Field of the Invention

The present invention relates to a data storage technology, and more particularly, to a data acceleration apparatus for Internet small computer system interface (iSCSI) that can provide high-speed data input/output and reduce a load of a host central processing unit (CPU), and an iSCSI storage system using the same.

2. Description of the Related Art

Vast amounts of data stored into a server have led to increase in required functions of a data storage apparatus. Thus, a common server that is directly connected with a storage apparatus often has a limitation in storing data on the storage apparatus. One resolution approach to this limitation is a method of connecting a server and a storage apparatus through a network.

Most commonly used network-based connection methods include a network file system (NFS), a network attached storage, a storage area network (SAN), and so forth.

NFS is a method of storing data in a file basis using the transmission control protocol (TCP) between common servers. However, this method often has a decreased capability of transmission when a file system has an increased load.

Similar to NFS, NAS stores data in a file basis through a TCP connection. However, NAS uses exclusive hardware for data storage to reduce a load of a server. However, a load of a file system, which is usually caused by a limitation in file-based data storage, may hinder an improvement on storage at a target apparatus.

Different from NFS and NAS, SAN is a method of connecting a storage apparatus with a server using an exclusive network and storing data in a block basis, so that the server is responsible for a load of the file system. As a result, the load of the storage apparatus can be reduced, resulting in an improvement on input/output functions. However, configuring the exclusive network for SAN is expensive and difficult to be implemented in wideband areas.

Hence, iSCSI is suggested for the limitations arising when using SAN. iSCSI is an Internet engineering task force (IETF) standard protocol that encapsulates SCSI commands into TCP/Internet protocol (IP) packets and supports block-based data transmission using an IP network. iSCSI stores data in a block basis, and transmits data through a commonly used IP network. Thus, iSCSI can easily implement and extend SAN while utilizing advantages of NAS and SAN.

However, according to the iSCSI protocol, since the storage apparatus and the server are connected through the IP network, lots of loads are generated while processing the TCP/IP.

U.S. Patent Application No. 2004-0174893 filed by Yoshihiro Saito with the United States Patent and Trademark Office (USPTO) on Feb. 23, 2004 and published on Sep. 9, 2004 in the name of NEC corporation teaches an iSCSI apparatus and a communication control method for the same. In this published patent application, received packets in an iSCSI storage system are classified using an intelligent network controller. If the received packets are not iSCSI packets, a first processor processes the packets, and in the case of the iSCSI packets, a second processor that processes only the iSCSI protocol processes the packets, so that input/output performance of the iSCSI is not degraded even if lots of general packets are received. However, the published patent application does not propose a method of decreasing a load generated due to the TCP/IP processing by a CPU. Despite that network performance can be improved by distributing the load using two processors, the corresponding TCP/IP processor may still have a heavy load.

As another approach, U.S. Patent Application No. 2004-0062267 filed by John Shigeto Minami et al. with USPTO on Jun. 5, 2003 and published on Apr. 1, 2004 reveals a gigabit Ethernet adapter supporting the iSCSI and IP security (IPsec) protocols. In the published patent application, a gigabit Ethernet controller is configured additionally with a processor, a memory and a program to process the TCP/IP, and the iSCSI or IPsec protocols. As a result, processing performance of the gigabit Ethernet adapter can be improved. However, in the case of the TCP/IP processing, when a general processor and a program are used, performance of the gigabit Ethernet adapter may be reduced as compared with an exclusive TCP offload engine (TOE) controller. If programs that process the aforementioned protocols are installed within the gigabit Ethernet controller, performance of the gigabit Ethernet controller may be reduced to a great extent.

Particularly, rapidly processing iSCSI input/output of the iSCSI storage apparatus, reducing the load of the host CPU, and optimizing a transfer path of iSCSI input/output data can help improving the performance. Thus, it may be difficult to achieve the optimized performance using the aforementioned conventional technologies.

In the iSCSI storage apparatus, when received data are stored using the iSCSI protocol, the data need to be transferred to a memory of a local system through a PCI bus of the local system and then to a disk controller. Hence, a bottleneck event may occur during the data transfer.

### SUMMARY OF THE INVENTION

Accordingly, the present invention is directed to a data acceleration apparatus for iSCSI and an iSCSI storage system using the same that substantially obviates one or more problems due to limitations and disadvantages of the related art.

An object of the present invention is to provide a data acceleration apparatus for iSCSI that can optimize a data transfer path, protect data, reduce a load of a host CPU and increase a processing speed, and an iSCSI storage system using the same.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a data acceleration apparatus for iSCSI and an iSCSI storage system using the same are provided.

According to an aspect of the present invention, there is provided a data acceleration apparatus for iSCSI, comprising an input/output (I/O) processor connected to an iSCSI storage system through a PCI bus and controlling a PCI bridge and a memory, the memory storing data according to the control by the I/O processor, serving as a buffer for processing a TCP/IP and an IPsec protocol, and providing a data storage space, a TCP/IP offload engine (TOE) controller receiving data to be read or written in the iSCSI storage system through the I/O processor, offloading a stack of the TCP/IP and processing the TCP/IP, and an IPsec controller processing the IPsec protocol for the inputted and outputted data.

Consistent with the embodiment of the present invention, the data acceleration apparatus may further comprise an internal PCI bus interconnecting the I/O processor, the memory, the TOE controller, and the IPsec controller with each other.

Consistent with the embodiment of the present invention, in the data acceleration apparatus, during a data reading operation, the I/O processor may read corresponding data from a storage unit of the iSCSI storage system and store the read data on the memory. The IPsec controller may encode the stored data. The TOE controller may process the TCP/IP for the encoded data and outputs the processed data. On the other hand, during a data writing operation, the TOE controller may receive corresponding data and process the TCP/IP for the received data. The IPsec controller may decode the processed data and transfer the decoded data to a storage unit of the iSCSI storage system.

Consistent with the embodiment of the present invention, the TOE controller and the IPsec controller may be implemented in hardware.

According to another aspect of the present invention, there is provided an iSCSI storage system, comprising a host CPU controlling data reading/writing according to an iSCSI protocol to control managing of data storage, a host memory connected to the host CPU, serving as a buffer for the processing by the host CPU and providing a storage space, a network controller connected to an external network, transferring data to the external network, and receiving the data from the external network, a disk controller reading data from a disk being a data storage unit and writing data on the disk, a bridge connecting the host CPU, the host memory, the network controller, and the disk controller with each other, a main PCI bus interconnecting the bridge, the network controller and the disk controller with each other, and a data acceleration apparatus connected to the main PCI bus, processing a TCP/IP and an IPsec protocol for data to be read and written at the disk controller in response to a data read/write command from the host CPU.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 illustrates a block diagram of a data acceleration apparatus for iSCSI according to an embodiment of the present invention;

FIG. 2 illustrates a block diagram of an iSCSI storage system using the data acceleration apparatus for the iSCSI according to an embodiment of the present invention;

FIG. 3 is a diagram to illustrate a data reading operation by the data acceleration apparatus for the iSCSI according to an embodiment of the present invention; and

FIG. 4 is a diagram to illustrate a data writing operation by the data acceleration apparatus for the iSCSI according to an embodiment of the present invention.

### DETAILED DESCRIPTION OF THE INVENTION

Reference will now be made in detail to various embodiments of the present invention, examples of which are illustrated in the accompanying drawings. For easier understanding, like reference numerals denote like elements even in different drawings. Those typical technologies known in the art will not be described to clarify the sprit and scope of the present invention.

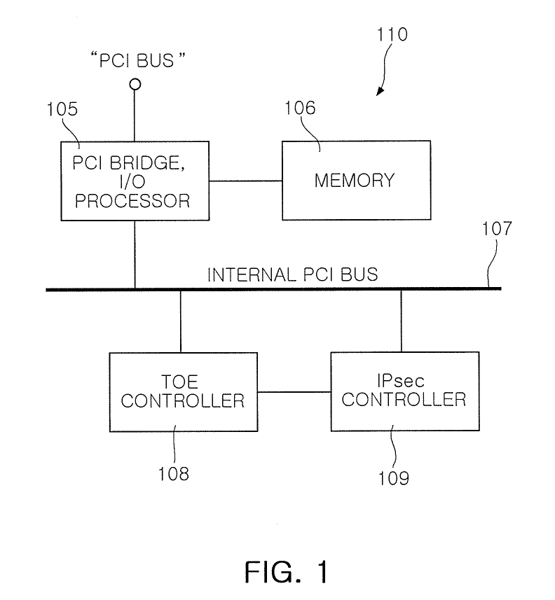

FIG. 1 illustrates a block diagram of a data acceleration apparatus for iSCSI. The data acceleration apparatus comprises an input/output (I/O) processor 105, a memory 106, a TOE controller 108, and IPsec controller 109. The I/O processor 105, the memory 106, the TOE controller 108, and the IPsec controller 109 are connected with each other through an internal PCI bus 107.

The I/O processor 105 is connected to a main PCI bus of an iSCSI storage system, and serves as a PCI bridge and a memory controller. In more detail, the I/O processor 105 performs an XOR operation using an XOR engine when calculating parity, and can reduce a load of a host CPU when implementing a redundant array of inexpensive disk (PAID) function so as to enhance stability and performance during disk storage. Also, instead of the host CPU, the I/O processor 105 rapidly performs a parity operation that is generally essential to process the iSCSI protocol. As a result, the I/O processor 105 allows the reduction in a load of the host CPU and accelerates the iSCSI processing speed.

The memory 106 serves as a buffer for processing the TCP/IP and IPsec protocols for inputted/outputted data, and stores the data.

The TOE controller 108 processes the Internet standard protocol (i.e., the TCP/IP) for the inputted/outputted data according to the control of the I/O processor 105. More specifically, the TOE controller 108 is a TCP/IP acceleration apparatus in which a TOE, which is a piece of NIC hardware, takes care of a load of the host CPU arising when processing the TCP/IP packets. The TOE controller 108, which is hardware, processes transport and network layers, which are usually processed by conventional software.

The IPsec controller 109 encodes and decodes the inputted/outputted data according to the control of the I/O processor 105. In detail, data inputted to the iSCSI storage system from an external network are decoded, while data transmitted through an IP network are encoded using a preset key. The IPsec controller 109 encodes and decodes the inputted/outputted data instead of the host CPU. As a result, the load of the host CPU of the iSCSI storage system can be reduced, and a high-speed iSCSI input/output function can be implemented.

Among the above-described elements of the data acceleration apparatus, the TOE controller 108 and the IPsec controller 109 are implemented in hardware.

In addition, the data acceleration apparatus is implemented in one personal computer, and the individual internal devices are connected with each other through the internal PCI bus 107.

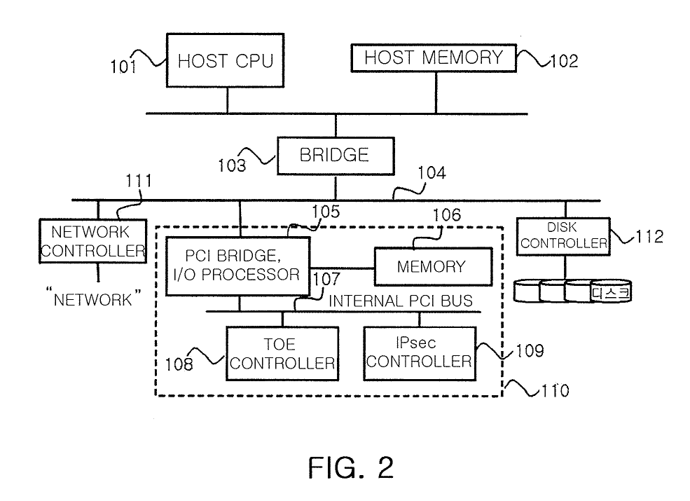

FIG. 2 illustrates a block diagram of an iSCSI storage system using the data acceleration apparatus illustrated in FIG. 1 according to another embodiment of the present invention.

The iSCSI storage system comprises a host CPU 101, a host memory 102, a bridge 103, a network controller 111, a disk controller 112, a main PCI bus 104, and the data acceleration apparatus 110. The host CPU 101 controls data reading and writing operations based on the iSCSI protocol. The host memory 102 is connected to the host CPU 101 to function as a buffer for the processing by the host CPU 101 and to provide a storage space. The bridge 103 provides an access to the host CPU 101 and the host memory 102. The network controller 111 connected to an external network, and transmits and receives data through the external network. The disk controller 112 reads data from a disk on which data are stored and write data on the disk. The main PCI bus 104 makes a connection between the bridge 103, the network controller 111 and the disk controller 112. The data acceleration apparatus 110 is connected to the main PCI bus 104 and processes the TCP/IP and IPsec protocols for the data that are read or written at the disk controller 112 according to read and write commands from the host CPU 101.

As described in FIG. 1, the data acceleration apparatus 110 comprises the I/O processor 105, the memory 106, the internal PCI bus 107, the TOE controller 108, and the IPsec controller 109. The I/O processor 105 is connected to the network controller 111, the bridge 103 and the disk controller 112 through the main PCI bus 104 of the iSCSI storage system.

The bridge 103 allows data transmission by interconnecting the host CPU 101 that controls and manages the iSCSI storage system in overall, the host memory 102 that is connected to the host CPU 101, and other devices including the network controller 111 and the disk controller 112 with each other. The network controller 111 makes a connection with an external network, and supports a TCP checksum for data inputted to or outputted from the external network, and scatter/gather transmission. Also, the network controller 111 performs zero-copy transmission for data stored on the memory 106. The zero-copy transmission results in exclusion of inter-memory copies. This exclusion of the inter-memory copies contributes to an improvement on the network transmission performance. The disk controller 112 reads data from and write data on the disk, which is a data storage unit of the iSCSI storage system.

The data acceleration apparatus 110 is connected to the iSCSI storage system through the main PCI bus 104.

When the disk controller 112 reads data from the disk, the data acceleration apparatus 110 stores the read data on the memory 106, and processes the TCP/IP and IPsec protocols using the TOE controller 108 and the IPsec controller 109. Afterwards, the data are transferred to the network controller 111. On the other hand, when the data inputted to the network controller 111 are written on the disk, the inputted data are stored on the memory 106, and the TOE controller 108 and the IPsec controller 109 process the TCP/IP and IPsec protocols. Afterwards, the data are transferred to the disk controller 112.

In the above iSCSI storage system, the host CPU 101 does not need to process the TCP/IP and IPsec protocols. Thus, the host CPU 101 has a reduced load. Also, the bottleneck event, which may occur during the data transfer, can be eliminated by minimizing the number of transferring data through the bridge 103.

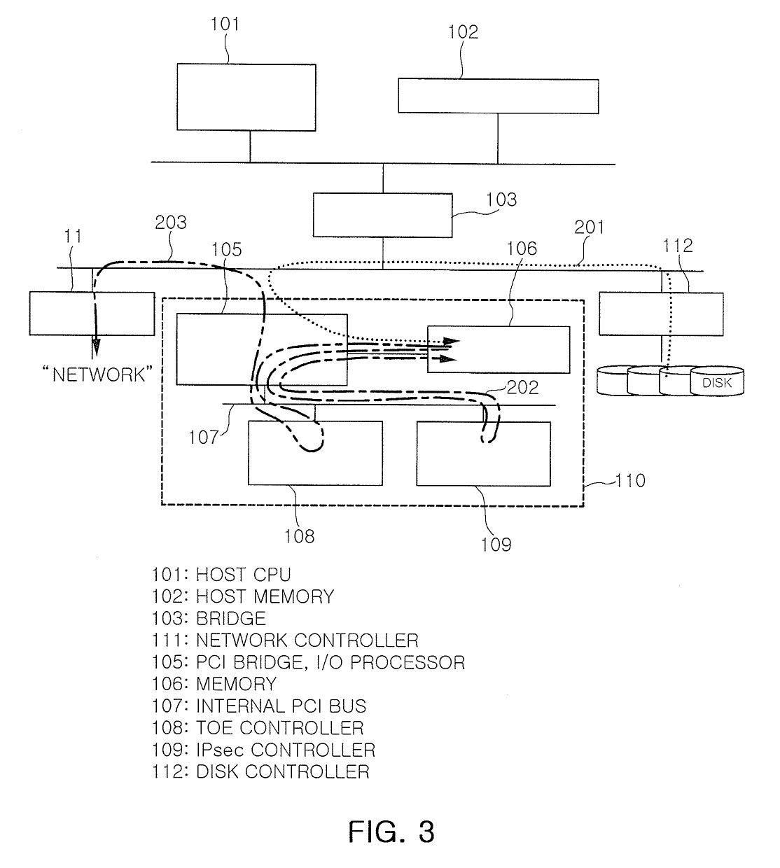

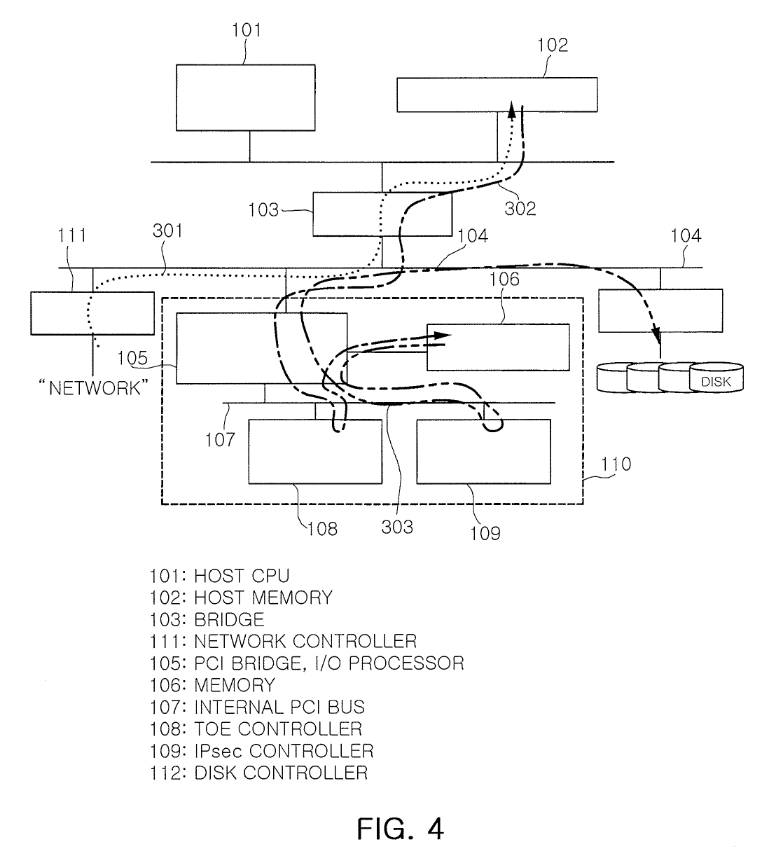

FIG. 3 is a diagram to illustrate a data reading operation using the data acceleration apparatus according to an embodiment of the present invention. FIG. 4 is a diagram to illustrate a data writing operation using the data acceleration apparatus according to an embodiment of the present invention.

The data reading operation will be described with reference to FIG. 3.

If the data reading from the disk in the iSCSI storage system is requested, a data reading command is transmitted from the host CPU 101 to the data acceleration apparatus 110. In this case, the data acceleration apparatus 110 reads data from the disk, which is a storage unit, and transfers the read data to an iSCSI initiator through a network.

At this time, the data processing for the high-speed data input/output proceeds as follows.

First, in operation of 201, the disk controller 112 reads the requested data on the disk, and stores the data on the memory 106 through the I/O processor 105 of the data acceleration apparatus 110. At this time, the stored data do not proceed with the processing of the TCP/IP and IPsec protocols.

Second, in operation of 202, the IPsec controller 109 receives the data stored on the memory 206 through the I/O processor 105, and encodes the corresponding data using a preset key. Afterwards, the encoded data are stored on the memory 106 through the I/O processor 105.

Third, in operation of 203, the TOE controller 108 reads the encoded data stored on the memory 106 through the I/O processor 105. The TOE controller 108 directly handles media access control (MAC) without interference from the host CPU 101, and offloads the entire stack of the TCP/IP and transfers the offloaded data to the network controller 111.

In the typical iSCSI storage system that does not comprise the data acceleration apparatus 110, for the data reading operation, data stored on the disk are read and transferred through the bridge. Then, the data are stored on the host memory, and the host CPU encodes the data and performs the TCP/IP processing. Afterwards, the data are transferred to the network controller through the bridge. As a result, the host CPU tends to have an increased load and a bottleneck event usually occurs at the bridge. In contrast, in the iSCSI storage system including the data acceleration apparatus 110 according to the embodiment of the present invention, once the host CPU 101 transfers the data read command to the data acceleration apparatus 110, the data acceleration apparatus 110, more particularly, interactions between the disk controller 112, the data acceleration apparatus 110 and the network controller 111 allows the processing of the TCP/IP and IPsec protocols and the execution of the data reading operation. Hence, the high-speed data processing can be realized. Since the data do not need to pass through the bridge 103, the bottleneck event does not occur at the bridge 103. Also, the load of the host CPU 101 can be reduced.

With reference to FIG. 4, the data writing operation in the iSCSI storage system will be described.

When the data writing is requested to the iSCSI storage system, a write command is transferred from the host CPU 101 to the data acceleration apparatus 110. The data acceleration apparatus 110 receive data transferred from an iSCSI initiator through a network. Then, the data acceleration apparatus 110 processes the TCP/IP of the received data and decodes the data. The decoded data are stored on the disk.

In more detail, the iSCSI-based data writing operation for the high-speed data input/output proceeds as follows.

First, in operation of 301, data that are transferred from an external network to be written on the disk are inputted to the network controller 111, and stored on the host memory 102 through the bridge 103. This operation is to perform basic operations including checking whether the data inputted from the external network are insecure data, which may cause damage to the security (e.g., hacking data). The host CPU 101 performs the basic operations. If the checking result by the host CPU 101 is normal (i.e., the normal data), the data write command is transferred to the data acceleration apparatus 110. If the checking result is not normal, the data are discarded.

Second, in operation of 302, the TOE controller 108 reads the data that are inputted from the external network and then stored on the host memory 102 through the I/O processor 105. The TOE controller 108 offloads the entire stack of the TCP/IP without interference from the host CPU 101 and stores the data on the memory 106 through the I/O processor 105.

Third, in operation of 303, the IPsec controller 109 receives the data processed by the TOE controller 108 and then stored on the memory 106 and decodes the received data using a preset key. Afterwards, the IPsec controller 109 transfers the decoded data to the disk controller 112 and stores the data on the disk.

According to the data writing operation, the host CPU 101 performs an operation of checking the normal or abnormal data and transfers the write command for the normal data to the data acceleration apparatus 110. The data acceleration apparatus 110 and the disk controller 112 perform the data writing operation. As a result, the CPU host 101 can have a reduced load, and data can process at high speed.

According to various embodiments of the present invention, when implementing the data storage apparatus, the data acceleration apparatus replaces the host CPU of the iSCSI storage system by protecting data, performing the TCP/IP and/or IPsec protocol processing, which often causes a bottleneck event, supporting a RAID function, and performing a parity operation. Hence, the data input/output can be accelerated through using the hardware (e.g., the TOE controller). Also, a load of the host CPU can be reduced and high-speed data input/output can be achieved.

According to the data acceleration method described in the above embodiments of the present invention, the number of copies between the memories during the iSCSI protocol processing can be minimized to thereby optimize the performance. Also, the number of data transfer through the PCI bus is minimized to eliminate the bottleneck event at the PCI bus.

The above described method according to the present invention can be embodied as a program and stored on a computer readable recording medium. The computer readable recording medium is any data storage device that can store data which can be thereafter read by the computer system. The computer readable recording medium comprises a read-only memory (ROM), a random-access memory (RAM), a CD-ROM, a floppy disk, a hard disk, an optical magnetic disk, and carrier waves such as data transmission through the Internet. The computer-readable recording medium can also be distributed over network-coupled computer systems so that the computer-readable code is stored and executed in a distributed fashion. Also, functional programs, codes, and code segments for accomplishing the present invention can be easily construed by programmers skilled in the art to which the present invention pertains.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A data acceleration apparatus for Internet small computer system interface (iSCSI), comprising:
an input/output (I/O) processor connected to an iSCSI storage system through a PCI bus and controlling a PCI bridge and a memory;
the memory for storing data according to the control by the I/O processor, serving as a buffer for processing a transmission control protocol (TCP)/Internet protocol (IP) and an IP security (IPsec) protocol, and providing a data storage space;
a TCP/IP offload engine (TOE) controller for receiving data to be read or written in the iSCSI storage system through the I/O processor, offloading a stack of the TCP/IP and processing the TCP/IP; and
an IPsec(IP security protocol) controller for processing the IPsec protocol for the inputted and outputted data.

2. The data acceleration apparatus of claim 1, further comprising an internal PCI bus interconnecting the I/O processor, the memory, the TOE controller, and the IPsec controller with each other.

3. The data acceleration apparatus of claim 1, wherein during a data reading operation, the I/O processor reads a data from a storage unit of the iSCSI storage system and stores the read data on the memory, the IPsec controller encodes the stored data, and the TOE controller processes the TCP/IP for the encoded data and outputs the processed data.

4. The data acceleration apparatus of claim 1, wherein during a data writing operation, the TOE controller receives a data and processes the TCP/IP for the received data, and the IPsec controller decodes the processed data and transfers the decoded data to a storage unit of the iSCSI storage system.

5. The data acceleration apparatus of claim 1, wherein the I/O processor performs an XOR operation using an XOR engine when implementing a redundant array of inexpensive disk (RAID) function.

6. The data acceleration apparatus of claim 1, wherein the I/O processor further performs a parity operation in processing the iSCSI protocol.

7. The data acceleration apparatus of claim 1, wherein the TOE controller and the IPsec controller are implemented in hardware.

8. An Internet small computer system interface (iSCSI) storage system, comprising:
a host central processing unit (CPU) controlling data reading/writing according to an iSCSI protocol to control managing of data storage;
a host memory connected to the host CPU, serving as a buffer for the processing by the host CPU and providing a storage space;
a network controller connected to an external network, transferring data to the external network, and receiving the data from the external network;
a disk controller reading data from a disk being a data storage unit and writing data on the disk;
a bridge connecting the host CPU, the host memory, the network controller, and the disk controller with each other;
a main PCI bus interconnecting the bridge, the network controller and the disk controller with each other; and
a data acceleration apparatus connected to the main PCI bus, processing a transmission control protocol (TCP)/Internet protocol (IP) and an IP security (IPsec) protocol for data to be read and written at the disk controller in response to a data read/write command from the host CPU.

9. The iSCSI storage system of claim 8, wherein the data acceleration apparatus comprises:
an input/output (I/O) processor connected to the main PCI bus and controlling a PCI bridge and a memory;
the memory storing data according to the control by the I/O processor, serving as a buffer for processing the TCP/IP and the IPsec protocol and providing a data storage space;
a TCP/IP offload engine (TOE) controller receiving data to be read/written at the iSCSI storage system through the I/O processor, offloading a stack of the TCP/IP, and processing the TCP/IP; and
an IPsec controller processing the IPsec protocol for the inputted and outputted data.

10. The iSCSI storage system of claim 9, wherein the data acceleration apparatus further comprises an internal PCI bus interconnecting the I/O processor, the memory, the TOE controller, and the IPsec controller with each other.

11. The iSCSI storage system of claim 9, wherein when the data acceleration apparatus receives the data read command from the host CPU, the I/O processor reads corresponding data from the disk controller and stores the data on the memory, the IPsec controller encodes the data, and the TOE controller processes the TCP/IP for the encoded data and outputs the data to the network controller.

12. The iSCSI storage system of claim 9, wherein when the data acceleration apparatus receives the data write command from the host CPU, the TOE controller receives corresponding data from the host memory and processes the TCP/IP; and the IPsec controller decodes the processed data and transfers the decoded data to the disk controller.

13. The iSCSI storage system of claim 9, wherein the TOE controller and the IPsec controller of the data acceleration apparatus are implemented in hardware.
